(19) United States
(12) Patent Application Publication
(10) Pub. No.: US 2022/0383772 A1
(43) Pub. Date: Dec. 1, 2022

(54) Method of interactive foreign language learning by voice talking each other using voice recognition function and TTS function

(71) Applicant: Jangho LEE, Seoul (KR)

(72) Inventor: Jangho LEE, Seoul (KR)

(21) Appl. No.: 17/458,230

(22) Filed: Aug. 26, 2021

(30) Foreign Application Priority Data
May 31, 2021 (KR) 10-2021-0070387

(51) Int. Cl. G09B 19/06; G09B 5/06; G10L 15/00; G10L 15/22; G10L 15/26; G06F 3/0488

(52) U.S. Cl. CPC G09B 19/06; G09B 5/06; G10L 15/005; G10L 15/22; G10L 15/26; G06F 3/0488; G10L 2015/223

(57) ABSTRACT

Disclosed is an interactive foreign language learning method that enables foreign language learning through conversation between a learner and a terminal having a screen, such as a smartphone, a tablet computer, a notebook computer, a personal computer (PC), and the like, based on a video containing foreign language sound expressions, such as movies, dramas, news, and the like, through speech transmission using a speech recognition function and a TTS function of the terminal. In the interactive foreign language learning method, upon determining that speech input by a learner in a speech waiting state for speech recognition matches a previously stored voice command, the terminal performs operation corresponding to the voice command and enters the speech waiting state again, and upon determining that the speech input by the learner does not match the voice command, the terminal allows the learner to perform foreign language learning in learning modes according to learner selection, such as a learning mode in which the learner speaks after the terminal, a conversation mode in which the terminal and a user alternately speaks a sentence, and an intermediate learning mode, while changing the learning modes in response to a voice command of the learner, whereby the learner can perform interactive foreign language learning through speech transmission between the terminal and the learner while minimizing screen touch, and can have actual conversation with other learners performing foreign language learning using the same application program implementing the learning method.

### CROSS-REFERENCE TO RELATED APPLICATION

This patent document claims priority to and the benefit of Korean Patent Application No. 10-2021-0070387, filed on May 31, 2021, the entire disclosure of which is incorporated by reference for all purposes as if fully set forth herein.

### FIELD

The present invention relates to an interactive foreign language learning method that enables foreign language learning through conversation between a learner and a terminal having a screen (hereinafter referred to as “terminal”), such as a smartphone, a tablet computer, a notebook computer, a personal computer (PC), and the like, based on video content (hereinafter referred to as “foreign language content” or “content”) containing foreign language sound expressions, such as movies, dramas, news, and the like, through speech transmission using a speech recognition function and a text-to-speech (TTS) function embedded in the terminal. More particularly, the present invention relates to an interactive foreign language learning method that enables broad learning of important elements of foreign language learning, that is, listening, speaking, reading and comprehension of foreign languages, through various methods suitably selected according to learner's learning stages, learning goals and surrounding circumstances, and that provides a means for connecting with other learners to allow a learner to use knowledge obtained through foreign language learning in communication with others such that the learner can easily communicate with another party through connection with the other party, based on a conversation-based foreign language learning method realized by a prior application patent of the inventors of the present invention (hereinafter referred to as “prior application patent”), by which a learner learns a foreign language through conversation with a terminal, such as a mobile phone and the like, through repetition of a process of inputting, by the learner, speech to the terminal using the terminal, recognizing the content of the speech by the terminal, and transmitting, by the terminal, a content sound or a TTS sound to the learner based on the recognized content.

### BACKGROUND

A typical foreign language learning method using foreign language content is mainly aimed at allowing a learner to enjoy video content executed by a terminal, and is neither carried out through conversation between the learner and the terminal via speech transmission by requesting the learner to learn a foreign language in the course of touching a screen of the terminal, thereby providing an insufficient opportunity for the learner to speak by himself or herself, nor adapted to allow the learner to learn foreign language expressions corresponding to subjects of foreign language video content and development of circumstances while sequentially following the foreign language video content having various subjects conducive to foreign language learning. Moreover, since various learning methods suitably selected and used by learners according to learner's learning ability, learning stage, and learning situation have not been developed in the art, it is very difficult for the learners to perform complex interactive foreign language learning using the foreign language content. Moreover, despite development of various methods allowing a foreign language learned by learners through the terminal to be used as a direct communication tool, there is no efficient learning method that allows learners learning the same foreign language to be connected to each other to use the foreign language that they have learned directly for interactive communication while being given motivation and interest in foreign language learning using a foreign language learning machine equipped with such a function. The present invention is conceived to solve such problems in the art.

Prior documents of the present invention include KR Patent Registration No. 10-0954498 (2010 Apr. 22.), No. 10-1125572 (2012 Mar. 23.), No. 10-1427528 (2014 Aug. 7.), and the like.

### SUMMARY

It is well known in the art that foreign language movies and dramas can be used as excellent textbooks for foreign language learning when used together with subtitles in native language by foreigners whose language is different. However, since such movies are not originally made for the purpose of foreign language learning for people in other countries, it is necessary to solve basic technical tasks in order to use the movies for the purpose of foreign language learning and to develop various learning methods, which can be used by learners without being bored in various ways according to learner's learning ability, learning stage, and surrounding environment, on such a technical basis.

In foreign language learning, methods generally used for foreign language learning, such as reading, writing, and understanding, must be appropriately mixed and used in addition to listening and speaking. To this end, it is important to allow such function to be realized in the same learning device or learning method without using separate learning devices or learning methods.

Furthermore, in foreign language learning, it is very important for a learner to directly use knowledge gained by learning a foreign language to actually communicate with others. However, there are various difficulties finding a partner who can use the foreign language that the learner has learned as a communication tool. The provision of a means for the learners to easily connect with others who are learning a foreign language in the same way such that the learners can learn from each other and use what they have learned in actual communication is an essential process that not only provokes learner's learning motivation and interest, but also enables the learners to figure out what they know for sure and which parts need more in actual communication.

Furthermore, movies are subtitled in various languages and can be enjoyed by people from different countries in different languages. Here, between people from different countries with different languages, not only the subtitles act as good textbooks for learning a second foreign language, but also do help in understanding a learning target language more accurately. The present invention also provides a method of using subtitles made in a foreign language other than a learner's native language (hereinafter referred to as second foreign language subtitles) for foreign language learning using movies and the like.

Embodiments of the present invention provide such learning methods.

In accordance with an aspect of the present invention, there is provided an interactive foreign language learning method through speech transmission using a speech recognition function and a TTS function of a terminal, wherein, in order to allow interactive foreign language learning through speech transmission between a terminal and a learner using foreign language content having texts of multiple foreign language learning sentences, interactive foreign language learning through speech transmission between the terminal and the learner is performed without screen touching by the learner or through minimization of screen touching by the learner by repeating a process in which the terminal informs the learner of a speech waiting state through a sound signal and/or screen display to allow the learner to input speech, executes operation in response to the speech input by the learner, and enters the speech waiting state again to allow the learner to input speech again.

According to the present invention, the terminal may previously store voice commands to be delivered from the learner to the terminal in a server or the cloud and may execute a function corresponding to a specific voice command and may enter the speech waiting state again, followed by informing the learner of the speech waiting state, upon determining that the speech input by the learner matches the specific voice command stored in the server or the cloud through comparison of the speech with the voice commands stored in the server or the cloud using a speech recognition function when the learner inputs the speech to the terminal in the speech waiting state.

According to the present invention, upon determining through comparison of the speech input by the learner in the speech waiting state with the voice commands stored in the server or the cloud that the speech input by the learner does not match any command stored in the server or the cloud, the speech may be compared with different target sentences according to various learning methods provided by the present invention to allow the learner to perform foreign language learning in various methods according to the comparison results. The learning methods will be described below in detail.

According to the present invention, the terminal may display a video or an image corresponding to a learning target sentence on a screen of the terminal to allow the learner to watch the video or the image, before, after, or while outputting a current learning target sentence or a next sentence of the current learning target sentence through foreign language content sound or TTS sound.

According to the present invention, the terminal may allow the current learning target sentence to be displayed on the screen of the terminal together with or without the next sentence of the current learning target sentence and subtitles corresponding to each of the learning target sentences in a native language according to learner selection.

According to the present invention, the terminal may display the total number of learning target sentences, a current learning target sentence number, a score given to the learner according to a learning result, and words not correctly spoken by the learner when the learner inputs speech with respect to an immediately previous learning target sentence, on the screen thereof.

According to the present invention, the terminal may allow the learner to perform foreign language learning with multiple learning methods while changing a current learning method to another learning method through a voice command without touching the screen thereof and may display the current learning method used by the learner on the screen while changing display of the current learning method to the other learning method when the current learning method is changed to the other learning method through the voice command.

According to the present invention, the terminal may display a list of the voice commands to be used by the learner on the screen thereof in response to a voice command from the learner.

According to the present invention, upon determining whether the speech input by the learner is similar to a learning target sentence, a method of determining similarity between the speech input by the learner and the learning target sentence may be changed according to a length of the learning target sentence and/or a degree of difficulty of the learning target sentence set by the learner.

The present invention may provide a means on which learners can perform writing with respect to the foreign language content to be learned by the learner.

The method according to the present invention may allow learners using the same application program implementing the present invention to have conversation with each other using foreign language expressions learned on the same application program through at least one selected from among text, voice phone, and video phone.

The interactive foreign language learning method through speech transmission using a speech recognition function and a TTS function of a terminal according to the present invention may allow a learner to have interactive conversation with the terminal based on a scene in foreign language content contained in the terminal while using the terminal like a native speaker friend or teacher accompanying the learner, and may allow the terminal to respond to speech of the learner by immediately determining whether a foreign language sentence spoken by the learner is correct such that the learner can repeatedly speak a correct foreign language sentence according to development of situations in a story of the foreign language content while following the story of the foreign language content, thereby making it possible for the learner to learn foreign languages naturally. Such a learning method neither requires much cost nor is restricted by place and time, thereby allowing the learner to learn correct pronunciation and intonation of foreigners in a short period of time through intensive and repeated learning depending on enthusiasm of the learner.

The method according to the present invention allows the learner to transmit almost all commands to the terminal via voice commands instead of touching the screen and to check which voice commands can be used through a list of voice commands. As such, the method according to the present invention allows the learner to improve the ability to speak a foreign language in a process of learning and speaking such commands and can prevent interruption of conversational learning due to screen touching by minimizing screen touching.

According to the present invention, since the terminal displays a video or an image corresponding to a learning target sentence on the screen thereof, the learner can memorize foreign language expressions together with situations in a story on the video or the image by learning the foreign language expressions according to development of the situations in the story based on the video or the image. Fundamentally, the terminal displays the learning target sentence together with subtitles corresponding thereto on the screen of the terminal, whereby the learner can perform foreign language learning based on comprehension of meanings and usage of foreign language expression spoken by the learner in various effective methods through intensive exercise of listening and speaking, with the entirety or part of a learning target sentence corresponding to a correct answer in a certain learning method.

The learning method according to the present invention allows a learner to install multiple learning methods in a single terminal to use the learning methods according to a learning stage and circumstances of the learner while changing the learning methods based on the list of the learning methods via voice commands, thereby enabling foreign language learning without boredom.

According to the present invention, the method of determining similarity between speech input by the learner and a learning target sentence may be changed according to the length of the learning target sentence and/or the degree of difficulty of the learning target sentence set by the learner, thereby enabling the learner to perform foreign language learning in a suitable degree of difficulty corresponding to the degree of difficulty of the learning target sentence and the learning stage of the learner.

The learning method according to the present invention allows the learner to know which sentence is a current learning sentence among the total learning target sentences, a score given to the learner in foreign language learning, and words incorrectly spoken by the learner among words constituting an immediately prior learning target sentence in the course of performing foreign language learning, whereby the learner can be motivated to speak more correctly and can perform foreign language learning with interest.

The present invention provides a means on which learners can perform writing, which is an important skill in foreign language learning, to allow the learners to perform foreign language learning in association with listening, speaking and reading, thereby enabling comprehensive foreign language learning.

The learning method according to the present invention may allow learners using the same application program implementing the present invention to have conversation with each other using learned foreign language content through text, voice phone and/or video phone, whereby the learners can easily find a conversation partner who learns the same content and can immediately use the learned foreign language content, thereby allowing the learner to check learning effects while improving motivation of foreign language learning.

### DRAWINGS

FIG. 1 is a flowchart of a command recognition process in an interactive foreign language learning method using a speech recognition function and a TTS function according to the present invention.

FIG. 2 is a flowchart of a learning mode of a foreign language learning process through speech input of a learner in the interactive foreign language learning method according to the present invention.

FIG. 3 is a flowchart of a conversation mode of the foreign language learning process through speech input of the learner in the interactive foreign language learning method according to the present invention.

FIG. 4 is a block diagram of the interactive foreign language learning method using a speech recognition function and a TTS function according to the present invention.

### DETAILED DESCRIPTION

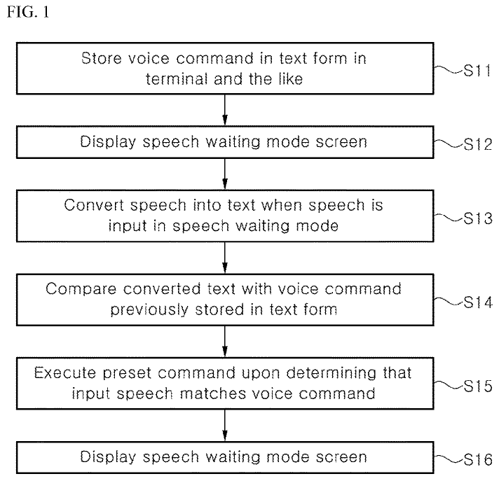

Hereinafter, an interactive foreign language learning method using a speech recognition function and a TTS function according to one embodiment of the present invention will be described with reference to FIG. 1 to FIG. 4.

The interactive foreign language learning method using a speech recognition function and a TTS function according to the embodiment of the present invention is an interactive foreign language learning method through reciprocal speech transmission using foreign language content containing a plurality of foreign language learning target sentences. Referring to FIG. 1, in the interactive foreign language learning method according to the embodiment of the invention, first, voice commands that can be transmitted to a terminal by a learner are previously stored in the form of text in the terminal or in a storage unit, such as a server or the cloud (Step S11). When an application program (app) is executed in the terminal to display a screen, the terminal displays a speech waiting state on the screen to receive speech input by the learner (Step S12). When the learner inputs speech in the speech waiting state in which the terminal can receive the speech input by the learner, the terminal converts the speech of the learner into text using the speech recognition function (Step S13), compares the content of the speech with a command previously stored in the form of text (Step S14), executes a corresponding command upon determining that the content of the speech matches a certain command (Step S15), and displays the speech waiting state on the screen thereof (Step S16). In the comparison step (Step S14), the terminal recognizes that the text converted from the speech input by the learner corresponds to text for foreign language learning upon determining that the text converted from the speech input by the learner in the speech waiting state does not match a certain command.

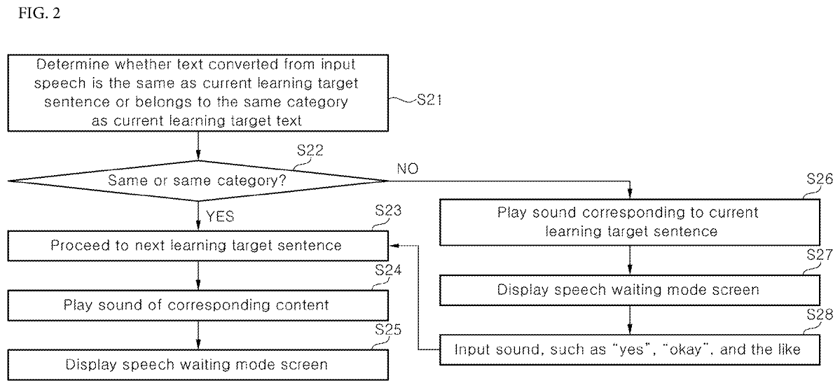

Upon determining that the speech input by the learner corresponds to the text for foreign language learning, a determination is made as to whether the speech input by the learner is the same as a current learning target sentence or belongs to the same category as the current learning target sentence (Step S21), as shown in FIG. 2. Upon determining that the text converted from the speech input by the learner is the same as the current learning target sentence or belongs to the same category as the current learning target sentence (Step S22), the terminal proceeds to the next learning target sentence (Step S23), reads the next learning target sentence to the learner with a sound of the foreign language content or a TTS sound of the terminal corresponding thereto (Step S24), and displays the speech waiting state on the screen (Step S25). Upon determining that the text converted from the speech input by the learner is neither the same as the current learning target sentence nor belongs to the same category as the current learning target sentence (Step S22), the terminal reads the corresponding target sentence to the learner with the sound of the foreign language content or the TTS sound until it is determined that the text converted from the speech input by the learner is the same as the current learning target sentence or belongs to the same category as the current learning target sentence (Step S26), and displays the speech waiting state on the screen again to allow the learner to speak again (Step S27). Here, when learning with respect to the current learning target sentence is repeated due to failure of the learner to continuously input speech that belongs to the same category as the current learning target sentence or when the learner inputs a preset voice command, such as “yes”, “okay”, “next”, “next sentence”, and “you speak the next sentence” (Step S28), the terminal may stop reading the current learning target sentence and may proceed to the next learning target sentence (Step S23).

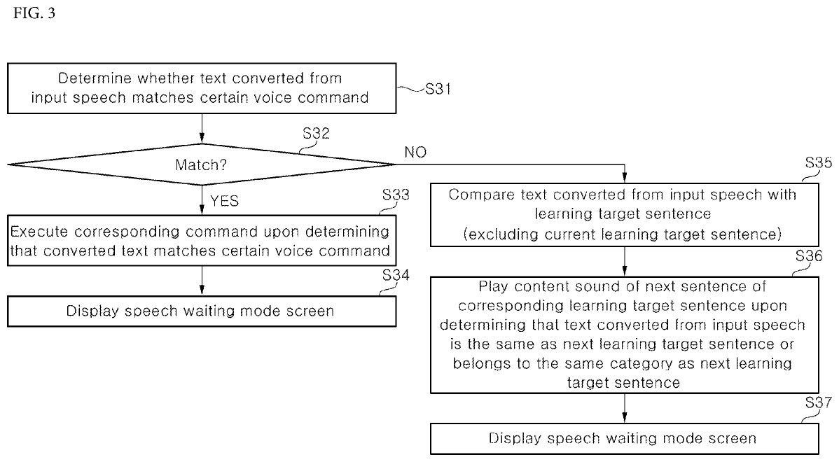

Next, upon determining that the text converted from the speech input by the learner does not match the command and corresponds to text for foreign language learning (Step S14), a determination is made as to whether the text converted from the speech input by the learner is the same as the next learning target sentence of the current learning target sentence or belongs to the same category as the next learning target sentence (Step S35), as shown in FIG. 3. Upon determining that the text converted from the speech input by the learner is the same as the next learning target sentence of the current learning target sentence or belongs to the same category as the next learning target sentence, the terminal reads the next learning target sentence to the learner with a sound of the foreign language content or a TTS sound of the terminal corresponding thereto of the corresponding foreign language learning target sentence, that is, a sentence next to the next learning target sentence of the current learning target sentence (Step S36), and informs the learner of the speech waiting state to allow the learner to speak the next learning target sentence (Step S37).

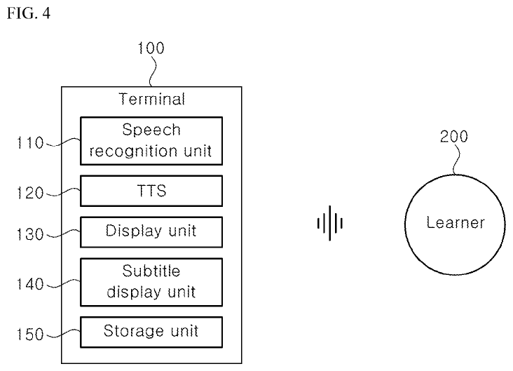

Referring to FIG. 4, which is a block diagram of the interactive foreign language learning method using a speech recognition function and a TTS function of a terminal according to the present invention, the terminal 100 may include a speech recognition unit 110, a text-to-speech (TTS) unit 120, a display unit 130, a subtitle display unit 140, and a storage unit 150 to recognize speech input by a learner 200 and to realize a function corresponding to the speech.

The interactive foreign language learning method according to the present invention may be carried out through speech transmission using a speech recognition function and a TTS function of the terminal by the speech recognition unit 110 and the TTS unit 120 of the terminal 100.

Further, interactive foreign language learning through speech transmission between the terminal and the learner is performed without screen touching by the learner or through minimization of screen touching by the learner by repeating a process in which the terminal informs the learner of a speech waiting state through a sound signal and/or screen display to allow the learner to input speech, executes operation in response to the speech input by the learner, and enters the speech waiting state again to allow the learner to input speech again.

The terminal 100 may include a conversion unit (not shown) and a comparison unit (not shown). The storage unit 150 of the terminal 100 may store voice commands to be delivered to the terminal by learners and the terminal may execute a waiting mode in which the speech waiting state is displayed on the screen, followed by informing the learner of the speech waiting state through the sound signal and/or the screen display via the display unit 130. When the learner inputs speech in the speech waiting state, the terminal may convert the content of the speech into text through a conversion unit (not shown) after determination of the content of the speech using the speech recognition function of the speech recognition unit 110, and may compare whether the converted text matches a certain command among the voice commands stored in the storage unit through the comparison unit (not shown).

Upon determining in the comparison unit that the converted text matches any one of the voice commands stored in the storage unit, the terminal may execute a function corresponding to the voice command and then enters the speech waiting state again, followed by executing the speech waiting mode in which the speech waiting state is displayed on the screen, followed by informing the learner of the speech waiting state.

Upon determining in the comparison unit that the converted text does not match any one of the voice commands stored in the storage unit, a determination is made as to whether the converted text is the same as a current learning target sentence in the learning target content or belongs to the same category as the current learning target sentence. Upon determining that the converted text is the same as the current learning target sentence or belongs to the same category as the current learning target sentence, the terminal proceeds to the next learning target sentence of the current learning target sentence to read the next learning target sentence with a sound of the foreign language content or a TTS sound of the terminal corresponding thereto and enters the speech waiting state again to allow the learner to input speech with respect to the next learning target sentence in the speech waiting state. Upon determining that the converted text is neither the same as the current learning target sentence nor belongs to the same category as the current learning target sentence, the terminal reads the current learning target sentence to the learner with a sound of the foreign language content or a TTS sound of the terminal corresponding thereto and enters the speech waiting state again to allow the learner to input speech again in the speech waiting state.

In addition, before, after or while the terminal 100 reads the current learning target sentence or the next learning target sentence with the sound of the foreign language content or the TTS sound of the terminal corresponding thereto, the terminal may display a video or an image corresponding to the learning target sentence on the screen of the terminal 100 through the display unit 130 to allow the learner to watch the video or the image.

Alternatively, the terminal 100 may display the content of the current learning target sentence and the next learning target sentence together with or without subtitles in a native language of the learner corresponding to each of the learning target sentences according to learner selection through the subtitle display unit 140.

With the learning mode and the conversation mode described above as fundamental learning methods, the present invention may provide various methods as follows in order to allow learners to perform foreign language learning in various ways according to learner's learning ability, learning stage, and surrounding environment. That is, in the above fundamental methods, when the content of the speech input by the learner does not match any one of the stored voice commands, the terminal determines that the learner speaks a certain sentence in the learning target content and executes a certain operation corresponding to the content of the speech input by the learner while allowing the learner to select and use one among various countermeasures provided by the terminal. In addition, for the method of displaying a learning target sentence and subtitles corresponding to the learning target sentence on the screen of the terminal, the present invention provides various methods that can be selected by learners. Details of the learning methods will now be described in the following description.

1. Description of claim 1 (a method of interactive foreign language learning through conversation between learner and terminal)

This learning method is the most fundamental interactive learning method. In this method, first, after foreign language content of a video containing multiple foreign language expressions is ready for execution, interactive foreign language learning through speech transmission between the terminal and the learner is performed without screen touching by the learner or through minimization of screen touching by the learner by repeating a process in which the terminal informs the learner of the speech waiting state through the sound signal and/or the screen display to allow the learner to input speech to the terminal in order to execute the sound recognition function, operates corresponding to the speech input by the learner through recognition of the content of the speech, enters the speech waiting state again, and informs the learner of the speech waiting state again to allow the learner to input speech again. This method enables interactive conversation between the terminal and the learner through continuous speech transmission therebetween. As the learner can listen to a learning target sentence in a foreign language and can speak the learning target sentence after the terminal by speech transmission from the terminal, the learner is able to continuously listen and speak, which are the most basic elements of foreign language learning. This method becomes the basis of all learning methods described below (hereinafter, this part is referred to as \textcircled{1} continuous interactive speech transmission part or as Component \textcircled{1}).

The terminal may previously store voice commands to be delivered from the learner to the terminal in the terminal or in a storage unit, such as a server or the cloud, and determines whether the content of speech input by the learner matches any one of specific voice commands stored in the terminal or the storage unit through the speech recognition function when the learner inputs the speech in the speech waiting state. Upon determining that the speech input by the learner matches any one of the specific voice commands, the terminal executes a function corresponding to a specific voice command and enters the speech waiting state again, followed by informing the learner of the speech waiting state. By such a voice command, interactive foreign language learning through continuous speech transmission between the terminal and the learner can be achieved without screen touching by the learner (hereinafter, this part is referred to as \textcircled{2} terminal response part in response to learner voice command or as Component \textcircled{2}).

Upon determining in the comparison step that the speech input by the learner does not match any one of the stored voice commands, the terminal determines that the learner speaks a certain sentence in the learning target content and operates corresponding to the content of the speech input by the learner while providing various methods that can be suitably selected by the learner according to the learner's learning ability and learning stage. Hereinafter, this part will be referred to as \textcircled{3} terminal response part in response to a voice command of a learner when the input speech is not a voice command or as Component \textcircled{3}. Component \textcircled{3} is divided into four different learning methods according to the content thereof and the learner uses one of the learning methods. Details of this component will be described below in detail. By Component \textcircled{3}, interactive foreign language learning can be achieved through continuous speech transmission between the terminal and the learner, and the learner can learn a foreign language naturally by making an effort to read the current learning target sentence with a pronunciation and intonation similar to the sound from the terminal in order to proceed to the next learning target sentence after finishing learning of the current learning target sentence. Here, a method of reading the current learning target sentence or the next learning target sentence with the content sound may be realized by various methods according to specification of the terminal. Fundamentally, a sound containing video is executed to deliver the sound together with an image displayed on the screen. For the method of reading the learning target sentences plural times according to learner selection, the terminal provides a setting screen to allow the learner to set the number of repetition times thereon and allows preset content set on the setting screen by the learner to be stored in the storage unit, and the learning target sentences are repeatedly read plural times with reference to the number of repetition times set in a function adapted to read the learning target sentences. For the method of executing the screen and the sounds corresponding to the learning target sentence, a method of repeatedly playing a video part corresponding to the learning target sentence may be used fundamentally. However, since there can be difficulty in repeatedly playing the video a number of times according to performance of the terminal and software adapted to play the video, only an audio part of the corresponding video part may be played or the corresponding video part may be converted into an audio file, such as mp3, which in turn is stored and used for repeated playback. Repetition of reading the learning target sentence to the learner with a TTS sound may be realized by repeating a code of reading the learning target sentence with the TTS sound by the number of repetition times selected by the learner.

Before, after or while the terminal reads the current learning target sentence or the next learning target sentence with the sound of the foreign language content or the TTS sound of the terminal corresponding thereto, the terminal may display a video or an image corresponding to the learning target sentence on the screen of the terminal to allow the learner to watch the video or the image. This operation can be a great advantage in use of the foreign language content as a textbook for foreign language learning, since remembering the situations in which such expressions are used together not only helps the learner memorize certain expressions, but also makes it possible to memorize in which situations it is appropriate to use such expressions in foreign language learning. Display of the video or image corresponding to the foreign language content (hereinafter, this part will be referred to as \textcircled{4} content video display part or as Component \textcircled{4}) may be suitably selected according to usage. When the video part corresponding to the learning target sentence is played, it is natural that the image is played together with the sound, and when the video is played once and the audio file is played to provide the content sound to the learner by the remaining number of repetition times due to a need for repetition of playing the sound, only an image corresponding to one scene of the video is displayed during playback of the audio file. In addition, when only the TTS sound of the terminal corresponding to the learning target sentence is played without providing the content sound corresponding thereto, only the video not containing the sound or the image may be played without playing the video containing the sound. When the video is played, a site for playing the video is secured on the screen of the terminal excluding some regions thereof, in which the current and next learning target sentences and the subtitles corresponding thereto are displayed, and the video corresponding to the current learning target sentence is played in the site by a general video playback method. Thus, detailed description thereof will be omitted. When the image is displayed, a stopped screen of the video corresponding to the learning target sentence may be used as the image or a separate image may be previously stored to be played in some embodiments. In these embodiments, the image may be displayed for 3 to 4 seconds and then allowed to automatically disappear by an Image Toast technique supported by Android studio, before, after or while the terminal reads the learning target sentence with the content sound or the TTS sound of the terminal.

The terminal displays the learning target sentence and the subtitles corresponding thereto on the screen thereof (hereinafter, this part will be referred to as \textcircled{5} part of displaying current and next learning target sentences and subtitles corresponding thereto or as component \textcircled{5}). For display of the learning target sentence and the subtitles, any one of a process of displaying the current and next learning target sentences together with subtitles corresponding to each of the learning target sentences in a native language of the learner; a process of marking some words of the current learning target sentence with blank spaces while displaying the remaining words of the current learning target sentence and the next learning target sentence together with the subtitles corresponding to the current and next learning target sentences in the native language of the learner; and a process of making the entirety of the next learning target sentence disappear on the screen of the terminal to allow the learner to infer the content of the next learning target sentence read by the terminal, followed by displaying the next learning target sentence such that the learner checks whether the inferred content of the next learning target sentence is correct, when the terminal reads the next learning target sentence to the learner, and displaying the learning target sentence on the screen when the terminal or the learner reads or speaks the learning target sentence for which inference and confirmation of the learner has finished may be suitably selected and used by the learner according to the learning content of the learner. Details of component \textcircled{5} will be additionally described in description of a learning method in which each of the display methods is selected.

The terminal may display the total number of learning target sentences, a current learning target sentence number, a score given to the learner according to a learning result, and words not correctly spoken by the learner when the learner inputs speech with respect to an immediately previous learning target sentence, on the screen thereof. By this operation of the terminal, since the learner can perform foreign language learning while checking the number of the current sentence among all sentences and accumulated scores acquired by the learner in the course of learning a foreign language, the learner can feel less bored in foreign language learning and can be motivated to learn a foreign language. In addition, the terminal extracts and displays words not correctly spoken by the learner when the learner inputs speech with respect to an immediately previous learning target sentence, on the screen thereof, thereby promoting the learner to make an effort to speak more correctly. The part of displaying additional data related to foreign language learning on the screen of the terminal in the course of foreign language learning will be referred to as \textcircled{6} learning-related additional data display part or as Component \textcircled{6}.

In Component \textcircled{6}, techniques for displaying the total number of learning target sentences, a current learning target sentence number, and a score given to the learner according to a learning result are well-known in the art. However, for better understanding, an exemplary code implemented using the Java language is as follows.

Display of the total number of learning target sentences and a current learning target sentence number:

sentenceNumber3.setText((sharedpreferences.getString(Snumber, “”)+“/”+textCount));

Calculation of a score given to the learner according to a learning result and display of accumulated scores:

String value=gradeText.getText( ).toString( );

int currentGrade=Integer.parseInt(value);

totalGrade=currentGrade+3;

gradeText.setText(Integer.toString(totalGrade));

gradeText2.setText(sharedpreferences.getString(Grade, “”));

In addition, in order to extract and display words not correctly spoken by the learner when the learner inputs speech with respect to an immediately previous learning target sentence, the terminal splits all texts obtained as a result of speech recognition for the learning target sentence and speech input by the learner are split by a blank space (“ ”) between words {split(“ ”)}, followed by extracting and displaying words not present in the text converted from the speech input by the learner among the words in the learning target sentence. An exemplary code for this operation implemented using the Java language is as follows.

vtext.contains((QUOTES[currentIndex-1].trim( )toLowerCase( )).split(“”)[0])

When the learner inputs speech while looking at learning target sentences displayed on the terminal, the learner can perform learning of the next learning target sentence by correctly speaking a simple and easy sentence. However, for a long, complicated or difficult sentence required for the learner to learn further, the learner is guided to repeatedly speak the entire sentence twice or more even when the learner correctly speaks the sentence. That is, even when the learner correctly speaks the sentence, the terminal determines that the learner incorrectly speaks the current learning target sentence and reads the current learning target sentence to the learner again to guide the learner to repeatedly speak the entire sentence twice or more while displaying the current learning target sentence on the screen, whereby the learner can perform sufficient exercises of foreign language speaking. Furthermore, although the learner speaks the learning target sentence at first while looking at the learning target sentence displayed on the screen of the terminal, the learner may try to memorize the learning target sentence without looking at the learning target sentence displayed on the screen when repeating the learning of speaking the current learning target sentence by continuously speaking the current learning target sentence twice or more as above. In addition, although the learner speaks after listening to the sentence read by the terminal at first, the learner can perform an exercise of speaking the sentence as soon as the learner listens to the sentence read by the terminal later. By this method, the learner is able to speak almost identically not only to the pronunciation or vocalization of a native speaker but also to stress, intonation and speaking rhythm of the native speaker. Such various deep learning methods may be applied to similar learning methods according to the present invention since the learner only needs to speak by continuously speaking the current learning target sentence twice or more without changing the learning method.

Next, details of the learning methods that can be selected by the learner by changing the content of each of Component \textcircled{3} (countermeasure part when the input speech is not a voice command) and Component \textcircled{5} (part of displaying current and next learning target sentence and subtitles of each of the learning target sentences) will be described.

(1) A learning method in which the learner learns each of learning target sentences in a sequential learning mode

This learning method corresponds to a learning method in the most fundamental learning mode. Upon determining in the comparison step that the content of the speech input by the learner does not match any one of the stored voice commands, the terminal determines whether the speech input by the learner is the same as a current learning target sentence in learning target content or belongs to the same category as the current learning target sentence. Upon determining that the speech input by the learner is the same as the current learning target sentence or belongs to the same category as the current learning target sentence, the terminal reads the next learning target sentence to the learner with a sound of the foreign language content or a TTS sound of the terminal corresponding thereto the number of times selected by the learner and enters the speech waiting state again to allow the learner to input speech again in the speech waiting state. Upon determining that the speech input by the learner is neither the same as the current learning target sentence nor belongs to the same category as the current learning target sentence, the terminal reads the current learning target sentence to the learner with the sound of the foreign language content or the TTS sound of the terminal corresponding thereto the number of times selected by the learner and enters the speech waiting state again to allow the learner to input speech again in the speech waiting state. In this learning method, Component \textcircled{5} (part of displaying current and next learning target sentence and subtitles of each of the learning target sentences) displays each of the current and next learning target sentences and the subtitles corresponding thereto.

(2) A learning method in which the learner is guided to speak a learning target sentence without listening to the sound of the terminal and the terminal reads the same sentence to the learner again.

This learning method includes the same components as Components \textcircled{1}, \textcircled{2}, \textcircled{4}, \textcircled{5} and \textcircled{6} of learning method (1) except for Component \textcircled{3}.

In this learning method, upon determining in the comparison step that the content of the speech input by the learner does not match any one of the stored voice commands, the terminal determines whether the speech input by the learner is the same as the current learning target sentence in the learning target content or belongs to the same category as the current learning target sentence. Upon determining that the speech input by the learner is the same as the current learning target sentence or belongs to the same category as the current learning target sentence, the terminal proceeds to the next learning target sentence to read a sentence spoken by the learner with a sound of the foreign language content or a TTS sound corresponding thereto, and enters the speech waiting state again to allow the learner to speak the next learning target sentence in the speech waiting state. Upon determining that the speech input by the learner is neither the same as the current learning target sentence nor belongs to the same category as the current learning target sentence, the terminal reads the sentence spoken by the learner with the sound of the foreign language content or the TTS sound of the terminal corresponding thereto and enters the speech waiting state again to allow the learner to speak the same sentence (current learning target sentence) again in the speech waiting state. This learning method may be used by learners who can speak foreign language sentences without listening to the foreign language sentences read by the terminal as a result of learning the foreign language using learning method (1). In this method, since the terminal repeats the sentence that the learner spoke earlier, the learner can repeat foreign language learning with the same sentence and can check a part that the learner did not check upon speaking earlier when the terminal reads the sentence to the learner again. In addition, since the learner is guided to speak the next learning target sentence of the sentence read to the learner by the terminal, this learning method can prevent the learner from feeling bored with foreign language learning upon continuously using only learning method (1) and has utility as an intermediate learning method that can be used before proceeding to the next learning method in a full-scale conversation mode. In this learning method, Component \textcircled{5} (part of displaying current and next learning target sentence and subtitles of each of the learning target sentences) displays each of the current and next learning target sentences and the subtitles corresponding thereto.

(3) A learning method in a conversation mode in which the terminal and the learner alternately speak one sentence at a time.

This learning method includes the same components as Components \textcircled{1}, \textcircled{2}, \textcircled{4}, \textcircled{5} and \textcircled{6} of learning method (1) except for Component \textcircled{3}.

In this learning method, upon determining that the content of the speech input by the learner does not match any one of the stored voice commands, the terminal determines whether the speech input by the learner is the same as the current learning target sentence in the learning target content or belongs to the same category as the current learning target sentence. Upon determining that the speech input by the learner is the same as the current learning target sentence or belongs to the same category as the current learning target sentence, the terminal reads the next learning target sentence with the sound of the foreign language content or the TTS sound of the terminal corresponding to the next learning target sentence and then proceeds to a sentence after the next learning target sentence to display the sentence after the next learning target sentence and a sentence after the sentence after the next learning target sentence on the screen thereof and enters the speech waiting state, followed by informing the learner of the speech waiting state. Upon determining that the speech input by the learner is neither the same as the current learning target sentence nor belongs to the same category as the current learning target sentence, the terminal reads the current learning target sentence to the learner with the sound of the foreign language content or the TTS sound of the terminal corresponding thereto and enters the speech waiting state again to allow the learner to input speech again in the speech waiting state. In this ways, the terminal and the learner can alternately speak one sentence through interactive speech transmission. When the learner fails to speak a learning target sentence correctly or similarly, the terminal reads the learning target sentence to the learner to guide the learner to speak after the terminal. This learning method is a learning method that can be used by the learner who can speak foreign language sentences as a result of learning the foreign language using learning methods (1) and (2). Since this learning method allows the learner to perform interactive foreign language learning through conversation with the terminal based on the content that the learner learns, this learning method is less boredom than the above learning methods and enables dynamic foreign language learning by continuing conversation based on the story of the foreign language content. In this learning method, Component \textcircled{5} (part of displaying current and next learning target sentence and subtitles of each of the learning target sentences) displays each of the current and next learning target sentences and the subtitles corresponding thereto.

(4) A learning method through combination of learning methods (1) and (3)

This learning method includes the same components as Components \textcircled{1}, \textcircled{2}, \textcircled{4}, \textcircled{5} and \textcircled{6} of learning methods (1) and (3) except for Component \textcircled{3} and is obtained through combination of learning methods (1) and (3).

In this learning method, upon determining that the content of the speech input by the learner does not match any one of the stored voice commands, the terminal determines whether the speech input by the learner is the same as the next learning target sentence in the learning target content or belongs to the same category as the next learning target sentence. Upon determining that the speech input by the learner is the same as the next learning target sentence or belongs to the same category as the next learning target sentence, the terminal proceeds to a learning target sentence after the next learning target sentence to reads the learning target sentence after the next learning target sentence to the learner with a sound of the foreign language content or a TTS sound of the terminal corresponding thereto and enters the speech waiting state, followed by informing the learner of the speech waiting state. Upon determining that the speech input by the learner does not match any one of the stored voice commands and is neither the same as the next learning target sentence nor belongs to the same category as the next learning target sentence, a determination is made as to whether the speech input by the learner is the same as the current learning target sentence in the learning target content or belongs to the same category as the current learning target sentence. Then, upon determining that the speech input by the learner is the same as the current learning target sentence or belongs to the same category as the current learning target sentence, the terminal reads the next learning target sentence to the learner with a sound of the foreign language content or a TTS sound of the terminal corresponding thereto and enters the speech waiting state again, followed by informing the learner of the speech waiting state. Upon determining that the speech input by the learner does not match any one of the stored voice commands and is neither the same as any one of the current and next learning target sentences nor belongs to the same category as any one of the current and next learning target sentences, the terminal reads the current learning target sentence to the learner with the sound of the foreign language content or the TTS sound of the terminal corresponding thereto and enters the speech waiting state again to allow the learner to input speech again in the speech waiting state.

This learning method is a combination of Components \textcircled{3} of learning methods (1) and (3). As described above, learning method (1) may be referred to as the learning mode and learning method (3) may be referred to as the conversation mode, and learning method (4) is the combination of these methods. That is, first, the speech input by the learner is compared with the next learning target sentence to determine whether the speech input by the learner is the same as the next learning target sentence or belongs to the same category as the next learning target sentence. Then, upon determining that the speech input by the learner is the same as the next learning target sentence or belongs to the same category as the next learning target sentence, learning method (3), that is, the conversation mode, is carried out to allow the terminal to read a sentence after the next learning target sentence spoken by the learner and to enter the speech waiting state again to allow the learner to input speech. In addition, upon determining that the speech input by the learner is neither the same as the next learning target sentence nor belongs to the same category as the next learning target sentence whereas the speech input by the learner is the same as the current learning target sentence read to the learner by the terminal or belongs to the same category as the current learning target sentence, the terminal reads the sentence after the next sentence of the sentence spoken by the learner in the learning mode of learning method (1); and when the speech input by the learner is neither the same as nor belongs to any one of the current learning target sentence and the next learning target sentence, the terminal reads the current learning target sentence to the learner to allow the learner to speak the current learning target sentence again by determining that the learner fails to correctly speak the current learning target sentence. Despite a disadvantage that the conversation mode is unintentionally preferred in foreign language learning when the current learning target sentence is similar to the next learning target sentence, this learning method is a useful learning method clearly distinguishable from learning methods (1) and (3) by providing an advantage that the learner can select to perform foreign language learning in the learning mode {learning method (1)} or to perform foreign language learning in the conversation mode {learning method (3)} even without changing the learning methods depending upon whether the learner speaks the current learning target sentence always displayed on the screen or the next learning target sentence. As described above, since the current and next learning target sentences are displayed together with the subtitles corresponding thereto on the screen, the learning method according to the present invention can provide an effect of allowing the learning mode to be automatically changed depending upon the learning target sentence spoken by the learner. In this learning method, Component \textcircled{5} (part of displaying current and next learning target sentence and subtitles of each of the learning target sentences) displays each of the current and next learning target sentences and the subtitles corresponding thereto.

(5) A learning method in which the terminal marks some words of a learning target sentence to be spoken by the learner with blank spaces to allow the learner to speak based on the content of the learning target sentence that the learner listens to and the content of subtitles in a native language of the learner through inference.

This learning method includes the same components as Components \textcircled{1}, \textcircled{2}, \textcircled{3}, \textcircled{4} and \textcircled{6} of learning method (1) except for Component \textcircled{5}.

In this learning method, the terminal marks some words of the current learning target sentence with blank spaces while displaying the remaining words of the current learning target sentence and the next learning target sentence together with the subtitles corresponding to the current and next learning target sentences in the native language of the learner on the screen thereof to allow the learner to speak current learning target sentence while inferring the words of the current learning target sentence marked with the blank spaces. This learning method may be used by learners who learn the corresponding foreign language to a considerable level using learning methods (1) to (4). That is, when the learner has learned the corresponding foreign language enough to speak the learning target sentence even without looking at some of the words constituting the learning target sentence, the learner may use this learning method to check whether he or she knows the content of the learning target sentence. Here, the words of the learning target sentence to be marked with the blank spaces may be determined in various ways according to embodiments. For example, the learning target sentence may be split by a split function for splitting a sentence via blank spaces (“ ”) for spacing words and odd-numbered words or even-numbered words in the learning target sentence may be marked starting from the first word with blank spaces with only an underline (“______”}.

This learning method not only allows the learner to check his or her skills according to the progress of foreign language learning, but also helps the learner to memorize foreign language sentences, thereby allowing the learner to perform foreign language learning without being bored upon foreign language learning in combination with other learning methods.

(6) A learning method in which, when the terminal reads the next learning target sentence to the learner, the terminal makes the entirety of the next learning target sentence disappear on the screen and reads the next learning target sentence to the learner with the sound of the foreign language content or the TTS sound of the terminal corresponding to the next learning target sentence the number of times selected by the learner such that the learner can infer the content of the learning target sentence read by the terminal without looking at the learning target sentence, followed by displaying the learning target sentence on the screen to allow the learner to speak a correct learning target sentence after checking the learning target sentence when the learner speaks an inferred learning target sentence.

This learning method includes the same components as Components \textcircled{1}, \textcircled{2}, \textcircled{3}, \textcircled{4} and \textcircled{6} of learning method (1) except for Component \textcircled{5}.

In this learning method, when the terminal reads the next learning target sentence to the learner by determining that the speech input by the learner does not match any one of the voice commands and is the same as the current learning target sentence or belongs to the same category as the current learning target sentence, the terminal reads the next learning target sentence to the learner with the sound of the foreign language content or the TTS sound of the terminal corresponding to the next learning target sentence the number of times selected by the learner, with the entirety of the next learning target sentence not displayed on the screen (the subtitles in a native language corresponding to the learning target sentence may be displayed or not displayed according to learner selection), such that the learner can infer the content of the learning target sentence read by the terminal without looking at the learning target sentence. Then, the terminal displays the content of the next learning target sentence on the screen and enters the speech waiting state, followed by informing the learner of the speech waiting state, such that the learner can speak the next learning target sentence after checking the learning target sentence inferred by the learner.

In this learning method, with the next learning target sentence not displayed on the screen of the terminal, the learner listens to the next learning target sentence and then speaks the next learning target sentence after checking the next learning target sentence displayed on the screen. Thus, it may be particularly useful for the learner when the learner learns the next learning target sentence after learning the current learning target sentence enough to correctly speak the current learning target sentence through application of the deep learning method described above in learning method (1).

In addition, although this learning method may be used by the learner after the learner is accustomed to listening to and speaking a foreign language to some extent by the learning methods listed above, intensive training of listening and speaking skills through this method from the beginning may be an effective way for some learners to achieve correct listening and speaking skills in a short period of time and to prevent inaccurate listening and speaking by repeating listening or speaking in the wrong way.

2. Description of claim 2 (the learning method according to claim 1, wherein the terminal displays learning methods to be selected by the learner together with a current learning method used by the learner, conversion from the current learning method into another learning method is performed by a voice command, and display of the current learning method is changed upon conversion of the learning method by the learner).

In this learning method, the terminal displays multiple learning methods to be selected by the learner and conversion of a current learning method into another learning method is performed by a voice command by the learner without touching the screen in claim 1. Since the present invention is aimed at natural foreign language learning through interactive conversation, it is necessary to prevent interruption of natural foreign language learning through interactive conversation due to screen touch instead of speech transmission. To this end, voice commands corresponding to a command for conversion of a current learning method into another learning method are previously stored such that the terminal can covert a current learning method into another learning method through recognition of the corresponding voice command and enters the speech waiting state, when the learner speaks the corresponding voice command to the terminal even without touching a button on the screen in order to convert the current learning method into the other learning method. For implementation of such a learning method, after determining a name representing each learning mode (for example, a name with “mode” added to the end of a phrase indicating characteristics of each learning method), a voice command is created and stored such that the corresponding learning method is executed when such a voice command is input.

To this end, the terminal displays the current learning method used by the learner on the screen and changes the current learning method into another learning method in response to the voice command from the learner, whereby the learner can determine a suitable learning method that the learner can currently use in foreign language learning and the terminal can covert the current learning method into the other learning method through recognition of the corresponding voice command when the learner speaks the voice command to convert the current learning method into the other learning method.

Components for implementation of this learning method will be described by way of example using learning methods (1) to (5) described above. A spinner (method of displaying several classifications, such as A, B, C, D, and E, as a list that automatically contracts and expands) for classification of the learning methods is provided to the screen to display each of the learning methods using the spinner. For example, a foreign language learning program is configured such that, when A is selected in the spinner for classification of the learning methods, foreign language learning is carried out in the most fundamental learning manner of learning method (1); when B is selected, foreign language learning is carried out by learning method (2) in which the learner is guided to speak first without listening to the sound of the terminal; when C is selected, foreign language learning is carried out in the conversation mode of learning method (3); when D is selected, foreign language learning is carried out by learning method (4) corresponding to combination of the learning mode and the conversation mode; when E is selected, foreign language learning is carried out by learning method (5) in which some words of the learning target sentence are marked by the blank spaces.

3. Description of claim 3 (the learning method according to claim 1, wherein the terminal displays a list of voice commands to be used by the learner on the screen thereof in response to a voice command of the learner)

In this learning method, the terminal displays the list of voice commands to be used by the learner on the screen in response to a voice command of the learner. It is not easy for the learner to memorize all voice commands presented by the present invention and use the voice commands before becoming a very skilled learner. Thus, it is very useful for the learner to display the list of voice commands provided by learner's voices on the screen, instead of touching a button on the screen to interrupt interactive foreign language learning through natural conversation and it is more useful to allow the learner to request the list of voice commands using a voice command rather than a screen touching method. Since the learner is required to input such a voice command in a foreign language recognized by the terminal, learning and speaking such voice commands can be a good foreign language learning method. The list of voice commands may be displayed in various ways. In one embodiment, the AlertDialog function provided by the Java language may be used. Details of the AlertDialog function are well known in the art and description thereof will be omitted herein.

4. Description of claim 4 (the learning method according to claim 1, wherein a method of determining similarity between the speech input by the learner and the learning target sentence is changed according to the length of the learning target sentence and/or the degree of difficulty of the learning target sentence set by the learner).

In this learning method, the method of determining similarity between the speech input by the learner and the learning target sentence in claim 1 is changed according to the length of the learning target sentence and/or the degree of difficulty of the learning target sentence set by the learner. Although the speech input by the learner and the learning target sentence are evaluated to be identical when a text sentence converted from the speech input by the learner is completely identical to the learning target sentence, similarity between two sentences may be determined by various methods. Upon determining that the two sentences are similar, the learner is allowed to learn the next learning target sentence after finishing learning with respect to the current learning target sentence, and upon determining that the two sentences are not similar, the learner is requested to repeat learning of the current learning target sentence. Although similarity between the sentences may be determined using various methods, similarity between the sentences is determined according to the length of the learning target sentence and/or the degree of difficulty of the learning target sentence set by the learner in any determination method, whereby the learner can perform interactive foreign language learning through natural conversation in a more suitable learning level for the learner. For example, when the same determination method is applied to a long sentence of more than 30 characters and a short sentence of less than 10 characters in length of the learning target sentence, it is very difficult to obtain similarity determination for the former sentence and it is very easy to obtain similarity determination for the latter sentence. Accordingly, in these two cases, when the determination method is designed and applied differently to provide similar difficulty, difficulty in determination of similarity between the sentences becomes similar, thereby preventing foreign language learning in a natural dialogue form from becoming too easy or difficult. In addition, when the learner is allowed to set the degree of learning difficulty such that the degree of similarity is determined very broadly for a beginner and is determined very narrowly for an advanced person, the learner can receive a determination corresponding to his or her foreign language level.

5. Description of claim 5 (the learning method according to claim 1, wherein additional voice commands capable of performing the same functions as the voice commands previously stored in the terminal or in the storage unit are further stored through registration to be used by the learner).

In this learning method, additional voice commands capable of performing the same functions as the voice commands previously stored in the terminal or in the storage unit in claim 1 may be further stored through registration to be used by the learner. For some learners, it is move helpful for foreign language learning to add another voice command performing the same function as a previously stored voice command such that the learners speak the added voice command to perform the same function rather than the previously stored voice command as is. Since the previously stored voice command is difficult or unclear for some learners to pronounce, a voice command of the learners is often recognized as an unclear voice command. In this case, it may be convenient for the learners to use additionally registered words or sentences that the terminal can recognize correctly without recognition error after registering additional words or sentences as voice commands through learner's pronunciation.

For implementation of this learning method, it is necessary to provide a means capable of storing an additional voice command corresponding to the previously stored voice command and generated by the learner by replacing a part of the previously stored voice command with another word or sentence in the same language or with a word or sentence in another language. To this end, when additional voice commands corresponding to some of the previously stored voice commands are input to the terminal by the learner, the terminal allows the additional voice commands to be stored corresponding to the previously stored voice commands. Then, upon determining that speech input by the learner is a voice command newly added by the learner and corresponding to any one of the previously stored voice commands, the terminal performs the same function as that of the previously stored voice command. For example, when speech input by the learner corresponds to an additionally stored voice command, the program according to the present invention is configured to recognize the input speech as a previously stored voice command by replacing the speech input by the learner with the previously stored voice command using a “replace( )” function that replaces one string with another string in the Java language implemented in Android Studio. That is, in the step of recognizing all speech input by the learner, it is checked whether the speech input by the learner includes the voice commands additionally added by the learner in order to recognize the speech as the previously stored voice command by replacing the speech input by the learner with strings of the previously stored voice command so as to correspond to such strings. To receive and store the additional voice commands input by the learner, a separate input window allowing the learner to input the additional voice commands is created to receive and store the additional voice commands corresponding to the previously stored voice commands in a file or in a database.

6. Description of claim 6 (the learning method according to claim 1, wherein, when the learner pushes a predetermined button on the screen or speaks a voice command corresponding thereto to perform writing exercises during foreign language learning, the terminal generates an input window adapted to allow the learner to directly input the foreign language content thereon such that the learner can perform the writing exercises)

In this learning method, the terminal is provided with a button for generating an input window for writing exercises on which the learner can directly input the learning target sentence and stores a voice command capable of performing the same function as an operation of pushing the button such that the input window for writing exercises can be generated when the learner speaks the corresponding voice command instead of pushing the button. When the learner pushes an end button on the input window, the terminal allows the input window to disappear and enters the speech waiting state again. The input window for writing exercises essentially consists of a button for closing the input window and a window displaying several lines, and is configured to automatically display a character board on which the learner inputs characters on the screen when the inputs window is displayed. This technique is realized by the Alertdialog technique of the Java language well known in the art.

7. Description of claim 7 (the learning method according to claim 1, wherein the learner is allowed to send or receive text messages, voice calls, or video calls with other learners performing foreign language learning using the same content through an application program implementing all or some of the learning methods described above)

In this learning method, the application program implementing all or some of the methods described above is further provided with a means for allowing the learner to send or receive text messages with other learners using the same application program, a means for allowing the learner to send or receive voice calls with the other learners, and/or a means for allowing the learner to send or receive video calls with the other learners, whereby the learners performing foreign language learning using the same content through the same application program can be linked to each other not only to practice what they have learned but also to have motivation for foreign language learning. In foreign language learning, an opportunity to apply what the learner has learned in practice provides powerful motivation for foreign language learning. In addition, this learning method enables the learner to remember what the learner has actually learned more clearly through direct communication with other people rather than listening to and speaking what the learner has actually learned alone.

In addition, this learning method allows the learner to perform foreign language learning using a single application program and to be directly linked to the other learners performing foreign language learning with respect to the same content through connection means of the other learners even without installing a separate application program or using a separate terminal, whereby persons who know each other can install the same application program on their terminals and can study the same content while being linked to each other within the same application program to send or receive text messages or voice calls, thereby remarkably improving the learning effect.

Such a learning method may be realized by the following method. That is, the terminal is provided with a means for allowing a user using the application program capable of implementing this learning method in addition to the various learning methods described above to be registered as a participant in communication with other users using the same application program by inputting data, such as user ID, user e-mail address, and user password when the user wants to participate in communication with the other users, a means for allowing users registered as participants to participate in communication with another user by inputting only e-mail addresses and passwords thereof, and a means for allowing the participants to send text messages to another party designated thereby. For methods for implementing these means, techniques that enable interactive communication while storing and updating data in real time through user registration and authentication via Firebase presented by Google, real time database, cloud storage, and the like are well known in the art and detailed description thereof will be omitted herein. Such a well-known technique may be additionally applied to the application program implementing this learning method to allow the learner to converse with other learners through a screen for such communication while performing foreign language learning in the same application program. Configuration of such application program is also well known in the art and detailed description thereof will be omitted herein.

When such a communication method is combined with the foreign language learning method using the foreign language content, such as films and the like, a very powerful effect in foreign language learning can be achieved. This is because the learner having learned a certain foreign language can communicate not only with foreigners speaking the same foreign language but also with other learners based on the foreign language content they have learned through an application program adapted to implement the common foreign language content. Such communication may be performed through one or multiple methods, such as text messages, voice calls, video calls, and the like. In general, for foreign language learners, an opportunity to use the foreign language they have learned will help them not only to clearly remember what they have learned, but also to know what they do not know in actual use and to supplement what they do not know by further learning the foreign language while motivating them to perform foreign language learning. However, such an opportunity in real life requires a lot of effort, time and money, whereas the application program for foreign language learning according to the present invention provides an opportunity for persons who want to use what they have learned in actual communication to be connected to each other naturally.

Communication through text messages may be realized by both individual chatting, which is a method of one-to-one communication between desired persons, and group chatting, which is a conversation method in which multiple persons form a group and anyone in the group participates in conversation, and technical features for these chatting methods are also well-known in the art.

8. Description of claim 8 (the learning method according to claim 7, wherein connection to a screen on which the learner can send the text messages, the voice calls or the video calls to the other learners performing foreign language learning through the same application program using the same learning method as the learner is realized when the learner pushes a button on the screen on which the learner performs foreign language learning or when the learner speaks a voice command corresponding to the button)

This learning method enables connection to a screen on which the learner can send text messages, voice calls or video calls to other learners performing foreign language learning using an application program employing the same learning method, when the learner performing foreign language learning using the method according to the present invention pushes the button on the screen or speaks a predetermined voice command in the speech waiting state of the terminal. This method enables the learner to directly use the foreign language content that the learner has newly learned in communication with the other learners while vividly memorizing the newly learned foreign language content, during foreign language learning using the learning method according to the present invention, whereby the learner can further strengthen the learned knowledge and can know a part for which the learner is required to perform additional learning due to insufficient learning in the course of trying to communicate with the other learners, thereby enabling efficient and convenient foreign language learning.

This method can be achieved by constituting a program such that a screen for communication with other learners is also present in a learning machine for foreign language learning or in the program, such as the learning method, so as to be displayed therein, and technical parts of such configuration can be achieved by integrating the program into a program of the foreign language learning method according to the present invention instead of forming the Firebase part of Google as a separate application program. Such a method is well known in the art and may be used as it is.

9. Description of claim 9 (the learning method according to claim 1, wherein, unlike claim 1 for the part when the speech input by the learner is not a voice command, the terminal sequentially reads previous learning target sentences to the learner a predetermined number of times before or after the learner starts to learn the next learning target sentence, or the terminal displays an input window on which the learner can perform writing exercises for a previously learned sentence after the learner finishes learning the current target learning sentence and before the learner starts to learn the next learning target sentence)

In this learning method, modified learning methods that can be selected by the learner are provided when the speech input by the learner is not a voice command as in the learning method of claim 1. In the learning method of claim 1, when the input speech is not a voice command, the learner is allowed to perform foreign language learning using any one method selected from among slightly modified learning methods based on the fundamental learning methods in the learning mode and in the conversation mode. On the contrary, in this learning method, when the input speech is not a voice command, as a more deepened learning method with advantages of the foreign language content, such as movies and the like, the learner is allowed to perform foreign language learning using any one of a learning method in which the terminal continuously reads a predetermined number of previous learning target sentences or the next learning target sentences to the learner in addition to the current and next learning target sentences such that the learner can perform foreign language learning in connection with the overall context of the foreign language content, such as movies and the like, and a learning method in which the terminal displays a window for writing exercises in addition to windows for listening and speaking exercises. This learning method is the same as the learning method of claim 1 except for a feature when the speech input by the learner is not a voice command and the feature of this learning method corresponds to one of methods described below in detail. Details of these methods will be described hereinafter.

(1) A learning method in which the terminal sequentially reads a predetermined number of previous learning target sentences to the learner before or after the learner starts to learn the next learning target sentence.

This learning method includes the same components as Components \textcircled{1}, \textcircled{2}, \textcircled{4}, \textcircled{5} and \textcircled{6} of learning method (1) except for Component \textcircled{3}.

In this learning method, before the learner proceeds to the next learning target sentence after finishing the current learning target sentence, the terminal sequentially reads a predetermined number of previous learning target sentences before or after the terminal reads the next learning target sentence to the learner the number of times selected by the learner to allow the learner to speak after the terminal. As a result, this learning method provides an effect of providing an opportunity for the learner to revive a memory of previous foreign language learning by sequentially listening to the previous foreign language sentences that the learner has learned. In addition, this method provides an effect that the learner can understand and remember sentences constituting a story of a movie by connecting the sentences to the context in which the sentences are used by sequentially listening to the content of the movie. One of the biggest advantages of learning a foreign language using content, such as movies, is that the learner can learn expressions that make up a story easy to remember by connecting the expressions as a whole. This learning method has an effect of further maximizing the advantages of the present invention for foreign language learning using content, such as a moving having a story and the like.

(2) A learning method in which the terminal reads the next learning target sentence to the learner and then sequentially reads a predetermined number of learning target sentences after the next learning target sentence before or after the learner starts to learn the next learning target sentence.

This learning method includes the same components as Components \textcircled{1}, \textcircled{2}, \textcircled{4}, \textcircled{5} and \textcircled{6} of learning method (1) except for Component \textcircled{3}.

In this learning method, after the learner finishes learning of the current learning target sentence, the terminal reads the next learning target sentence to the learner and then sequentially reads a predetermined number of learning target sentences after the next learning target sentence before or after the terminal reads the next learning target sentence to the learner the number of times selected by the learner to allow the learner to start learning of the next learning target sentence. As a result, the learner can infer not only the content of the next learning target sentence but also the content of learning target sentences after the next learning target sentence while sequentially listening to the next learning target sentence and some learning target sentences after the next learning target sentence without subtitles therefor. When foreign language learning is performed using this method, it is possible for the learner to infer the content of the following learning target sentences by listening to the following learning target sentences in advance several times without subtitles therefor. Thus, this learning method is very useful for listening exercises. In addition, in this learning method, since the learner can start foreign language learning after sequentially listening to the next learning target sentences, the learner can infer expressions in the story from the whole story, thereby enabling intensive listening exercises with respect to actual foreign movies or dramas.

(3) A learning method in which the terminal allows the learner to start learning of the next learning target sentence after sequentially reading a predetermined number of previous learning target sentences, the next learning target sentence, and learning target sentences after the learning target sentence to the learner

This learning method includes the same components as Components \textcircled{1}, \textcircled{2}, \textcircled{4}, \textcircled{5} and \textcircled{6} of learning method (1) except for Component \textcircled{3}.

In this learning method, when the learner wants to learn the next learning target sentence after finishing learning of the current learning target sentence, the terminal allows the learner to start learning of the next learning target sentence after sequentially reading a predetermined number of sentences selected from among previous learning target sentences that the learner has learned, the next learning target sentence, and learning target sentences after the learning target sentence the number of times selected by the learner. This learning method is a combination of learning methods (1) and (2) and thus has all advantages thereof. In this learning method, the number of previous learning target sentences and the number of learning target sentences that the terminal reads to the learner before the learner starts learning of the next learning target sentence may be suitably set to improve a learning effect as much as possible. Here, since listening to too many sentences takes too much time and thus deteriorates concentration on learning of the next learning target sentence, the number of sentences that the terminal reads to the learner may be restricted to 3 or 4 sentences. As a result, this learning method provides an effect of guiding the learner to review sentences that the learner has already learned among expressions in a story, a listening exercise effect of guiding the learner to infer the content of the next learning target sentences by listening to the next learning target sentences without subtitles, and an effect of guiding the learner to remember the expressions constituting a part of the story along with the context of the story.

(4) A learning method in which, before the learner proceeds to the next learning target sentence after finishing the current learning target sentence, the terminal displays an input window on which the learner performs writing exercises with respect to sentences that the learner has learned, converts the screen into another screen for learning the next learning target sentence when the learner pushes an end button on the input window, and enters the speech waiting state to allow the learner to input speech.

In this learning method, before the learner proceeds to the next learning target sentence after finishing learning of the current learning target sentence, the terminal automatically displays an input window for writing exercises, on which the learner can input the current learning target sentence, without screen touching or the voice command of the learner such that the learner can perform additional writing exercises with respect to the sentences that the learner has learned, converts the screen into another screen for learning the next learning target sentence when the learner pushes an end button on the input window for writing exercises on the screen, and enters the speech waiting state to allow the learner to input speech. By this method, each time the learning target sentence is changed, the learner can additionally perform the writing exercises with respect to the learning target sentence that the learner has learned through listening and speaking exercises. To this end, when the speech input by the learner does not belong to any one of the voice commands and is the same as the current learning target sentence or belongs to the same category as the current learning target sentence, the terminal displays the input window for writing exercises and enters the speech waiting state to allow the learner to input speech for learning of the next learning target sentence when the learner pushes the end button after finishing the writing exercises. The learner can more correctly learn and memorize the content of the learning target sentences in the course of performing the writing exercises based on this method. Since importance of the writing exercises in foreign language learning is also well-known in the art, the interactive foreign language learning method according to the present invention further provides an opportunity for the learner to perform the writing exercises, thereby providing a comprehensive and complete foreign language learning method. A method of displaying the input window for writing exercises is the same as the method described in claim 6.

10. Description of claim 10 (A learning method in which second foreign language subtitles are provided as text for foreign language learning such that, with some words of the second foreign language subtitles marked with blank spaces, the remaining words of the second foreign language subtitles are displayed on the screen to allow the learner to speak the second foreign language subtitles by inferring the words marked with the blank spaces)

This learning method includes the same components as Components \textcircled{1}, \textcircled{2}, \textcircled{4} and \textcircled{6} of learning method (1) except for Components \textcircled{3} and \textcircled{5}, and is a learning method in which learning method (4) for the learning target sentence of the foreign language content is applied to learning of the second foreign language subtitles.

In this learning method, upon determining in the comparison step that the content of the speech input by the learner does not match any one of the stored voice commands, a determination is made as to whether the speech input by the learner is the same as second foreign language subtitles of the current learning target sentence in the learning target content or belongs to the same category as the second foreign language subtitles. Then, upon determining that the speech input by the learner is the same as the second foreign language subtitles or belongs to the same category as the second foreign language subtitles, the terminal proceeds to the next learning target sentence to read the second foreign language subtitles corresponding to the next learning target sentence to the learner with a TTS sound corresponding thereto the number of times selected by the learner, and enters the speech waiting state again, followed by informing the learner of the speech waiting state. Upon determining that the speech input by the learner is not the same as the second foreign language subtitles or does not belong to the same category as the second foreign language subtitles, the terminal reads the second foreign language subtitles corresponding to the current learning target sentence to the learner with a TTS sound corresponding thereto the number of times selected by the learner, and enters the speech waiting state again to allow the learner to input speech in the speech waiting state.

In addition, the terminal displays some words of the second foreign language subtitles corresponding to the current learning target sentence with blank spaces while displaying the remaining words of the second foreign language subtitles on the screen thereof together with the current learning target sentence, the next learning target sentence, and second foreign language subtitles of the next learning target sentence to allow the learner to speak the content of the second foreign language subtitles corresponding to the current learning target sentence while inferring the words of the second foreign language subtitles of the current learning target sentence marked with the blank spaces. Among the technical features for realizing this learning method, the technical feature of allowing the terminal to read a second foreign language to the learner can be easily realized by the TTS function of the terminal and detailed description thereof will be omitted herein. In addition, the technical feature of marking some words of the second foreign language subtitles with blank spaces is the same as that described in learning method (5) of claim 1.

This technical feature provides an effect of guiding the learner to speak the second foreign language subtitles corresponding to the learning target sentence while inferring the content of portions of the learning target sentence marked with the blank spaces. In this learning method, the terminal converts a language for speech recognition into the second foreign language in order to determine whether the speech input in the second foreign language by the learner is the same as the learning target sentence in the second foreign language.

11. Description of claim 11 (the learning method according to claim 10, wherein the terminal allows the learner to select a language among languages used for subtitles displayed on the screen as a subtitle language to be read by the terminal and displays the name of the subtitle language selected by the learner on the screen)

In this learning method, the terminal allows the learner to select a language among multiple languages used for subtitles displayed on the screen as a subtitle language to be read by the terminal and displays the name of the subtitle language selected by the learner on the screen such that the learner can see the selected language. As a result, the learning method can secure efficient learning of the second foreign language. To this end, the terminal is adapted to provide a setting screen on which the learn can select the subtitle language to be read by the terminal among languages for subtitles in the application program implementing the learning method according to the present invention, to store and display the content of the subtitle language selected by the learner, and to refer to the stored data upon reading the second foreign language subtitles.

12. Description of claim 12 (a learning method wherein the terminal reads a series of learning target sentences in various ways such that the learner internally repeats a sentence read to the learner by the terminal or the next sentence)

This learning method may be used in the case where interactive learning through speech transmission between the terminal and the learner is difficult. Unlike the learning methods described above, this learning method can be advantageously used in the case where it is difficult for the learner to speak with his or her own mouth. This method may be used when the terminal does not clearly recognize the speech input by the learner due to noisy surroundings, when it is difficult for the learner to speak out loud in use of public transportation or the like, or when the learner want to perform foreign language learning while resting at home or doing housework, etc.

In this learning method, although the terminal does not receive the speech input by the learner in the speech waiting state, a process in which the terminal gives the learner time to speak the content aloud after the terminal or to speak internally after the terminal, followed by reading the next sentence to the learner is repeated, thereby providing a similar learning effect to the learning methods described above. In addition, when the time given to the learner to speak after the terminal is reduced, this method provides an effect of allowing the learner to watch the foreign language content almost similar to watching movie content and the like.

In this learning method, as in Components \textcircled{4} and \textcircled{5} of learning method (1) in description of claim 1, before, after or while the terminal reads the current learning target sentence or the next learning target sentence with the sound of the foreign language content or the TTS sound of the terminal corresponding thereto, the terminal may display a video or an image corresponding to the learning target sentence on the screen of the terminal to allow the learner to watch the video or the image. In addition, the terminal may display the content of the current learning target sentence and the next learning target sentence together with or without the entirety or some of subtitles in a native language of the learner corresponding to each of the learning target sentences on the screen thereof according to learner selection. This feature is just like the case where the learner watches a movie for foreign language learning, with all or some of foreign language subtitles or native language subtitles hidden. In this learning method, although the terminal does not react in response to the content spoken by the learner, there is an effect that the learner can continue foreign language learning while watching or inferring the video or image displayed on the screen by the terminal and the content of each of the learning target sentences and the subtitles therefor.

In this learning method, the terminal continues to read a preset number of learning target sentences set by the learner from the current learning target sentence, to read the learning target sentences from the current learning target sentence to the last learning target sentence, or to read the learning target sentences from the current learning target sentence until the learner stops the terminal reading the learning target sentences. Here, various learning effects can be obtained depending upon the configuration of a reading method. The learning methods that vary depending upon the reading methods will be described as follows.

(1) A learning method in which the terminal sequentially reads the learning target sentences to guide the learner to speak internally after the terminal.

In this learning method, the terminal repeats a process of sequentially reading a preset number of learning target sentences set by the learner from the current learning target sentence with sounds of the foreign language content or TTS sounds of the terminal corresponding to the learning target sentences, sequentially reading the learning target sentences with the sound of the foreign language content or the TTS sound from the current learning target sentence to the last learning target sentence, or sequentially reading the learning target sentences with the sound of the foreign language content or the TTS sound from the current learning target sentence until the learner stops the terminal reading the learning target sentences, giving the learner time to speak aloud after the terminal or to speak internally after the terminal, followed by reading the next learning target sentence.

In this learning method, as in Components \textcircled{4} and \textcircled{5} of learning method (1) in description of claim 1, before, after or while the terminal reads the current learning target sentence or the next learning target sentence with the sound of the foreign language content or the TTS sound of the terminal corresponding thereto, the terminal may display a video or an image corresponding to the learning target sentence on the screen of the terminal to allow the learner to watch the video or the image. In addition, the terminal may display the content of the current learning target sentence and the next learning target sentence together with or without the entirety or some of subtitles in a native language of the learner corresponding to each of the learning target sentences on the screen thereof according to learner selection. This feature is just like the case where the learner watches a movie for foreign language learning, with all or some of foreign language subtitles or native language subtitles hidden. In this learning method, although the terminal does not react in response to the content spoken by the learner, there is an effect that the learner can continue foreign language learning while watching or inferring the video or image displayed on the screen by the terminal and the content of each of the learning target sentences and the subtitles therefor.

In order to implement this learning method, a technique of allowing the terminal to repeatedly execute the same type of function for a long period of time is used. Such a technique is based on various methods depending upon the app development tool or programming language. In some embodiments of the invention, the AsyncTask technique {a function for executing content on the background for a relatively long period of time (doinBackground function) and a function for updating screen display in real time (onProgressUpdate function) are executed in parallel} supported by Android Studio is used. A feature of repeating a process of allowing the terminal proceeding to the next learning target sentence to give the learner time to repeat the learning target sentence after the terminal is executed by the doinBackground function and a feature of updating screen display to allow the corresponding video to be played whenever the learning target sentence is changed is executed by the onProgressUpdate function. For details of this technique, refer to (https://developer.android.com/reference/android/os/AsyncTask.Status) presented by Google and detailed description thereof will be omitted herein.

(2) A learning method in which the terminal reads a corresponding subtitle in a native language of the learner before reading the learning target sentence to the learner by the above learning method (1).

In this learning method, the terminal repeats the process of sequentially reading a preset number of learning target sentences set by the learner from the current learning target sentence with sounds of the foreign language content or TTS sounds of the terminal corresponding to the learning target sentences after reading subtitles therefor with the TTS sound, sequentially reading the learning target sentences with the sound of the foreign language content or the TTS sound from the current learning target sentence to the last learning target sentence after reading subtitles therefor with the TTS sound, or sequentially reading the learning target sentences with the sound of the foreign language content or the TTS sound from the current learning target sentence after reading subtitles therefor with the TTS sound until the learner stops the terminal reading the learning target sentences, giving the learner time to speak the content aloud after the terminal or to speak internally after the terminal, followed by reading the next learning target sentence. In addition, before, after or while the terminal reads the current learning target sentence or the next learning target sentence with the sound of the foreign language content or the TTS sound of the terminal corresponding thereto, the terminal may display a video or an image corresponding to the learning target sentence on the screen of the terminal to allow the learner to watch the video or the image. In addition, the terminal may display the content of the current learning target sentence and the next learning target sentence together with or without the entirety or some of subtitles in a native language of the learner corresponding to each of the learning target sentences on the screen thereof according to learner selection.

In addition to the features of the above learning method (1), this learning method further includes a feature in which the terminal reads the corresponding subtitles with the TTS sound in a native language of the learner before reading the learning target sentence with the sound of the foreign language content or the TTS sound of the terminal. With this feature, this learning method has different learning effects from the above learning method (1) in that the learner can perform foreign language learning while clearly recognizing the meaning of the learning target sentence even without watching the screen of the terminal, can infer the content of the corresponding learning target sentence when the terminal first reads the subtitle in the native language of the learner, and can check whether his or her inference is correct when the terminal reads the next learning target sentence to the learner.

Among technical features for implementing this learning method, the feature of allowing the terminal to read the subtitle in the native language with the TTS function is well-known in the art that does not require special description and the other features are the same as those described in the above learning method (1). In some embodiments of the invention, the feature of allowing the terminal to read the subtitle is further added to the onProgressUpdate function for updating screen display in real time while playing the corresponding video whenever the learning target sentence is changed in the AsyncTask technique in the above learning method (1). However, the feature of allowing the terminal to read the subtitle does not require screen update and thus may be executed in the background.

(3) A learning method in which the terminal further reads corresponding subtitles in a second foreign language after reading the learning target sentence to the learner by learning method (1).

In this learning method, the terminal repeats a process of sequentially reading a preset number of learning target sentences set by the learner from the current learning target sentence with sounds of the foreign language content or TTS sounds of the terminal corresponding to the learning target sentences, sequentially reading the learning target sentences with the sound of the foreign language content or the TTS sound from the current learning target sentence to the last learning target sentence, or sequentially reading the learning target sentences with the sound of the foreign language content or the TTS sound from the current learning target sentence until the learner stops the terminal reading the learning target sentences, reading second foreign language subtitles of the learning target sentence with a TTS sound, giving the learner time to speak the content aloud after the terminal or to speak internally after the terminal, followed by reading the next learning target sentence. In addition, before, after or while the terminal reads the current learning target sentence or the next learning target sentence with the sound of the foreign language content or the TTS sound of the terminal corresponding thereto, the terminal may display a video or an image corresponding to the learning target sentence on the screen of the terminal to allow the learner to watch the video or the image. In addition, the terminal may display the content of the current learning target sentence and the next learning target sentence together with or without the entirety or some of subtitles in a native language of the learner corresponding to each of the learning target sentences on the screen thereof according to learner selection.

In addition to the features of the above learning method (1), this learning method further includes a feature in which the terminal reads the learning target sentence with the sound of the foreign language content or the TTS sound of the terminal, followed by reading the corresponding second foreign language subtitles with the TTS sound. The feature of allowing the terminal to read the second foreign language subtitles can be a well-known technique that can be easily implemented by a TTS function of the terminal (when text is provided for most languages in the world, the TTS function presented by Google allows the terminal to read the text through recognition of the language. Thus, there is no need for special technology) and detailed description thereof will be omitted. For the learner who has learned a target foreign language to some extent and knows the meaning of a foreign language sentence, this learning method is useful when the learner learns the content of the corresponding second foreign language subtitles based on the knowledge of the foreign language sentence. In this learning method, for the learner understanding the meaning of a learning target sentence when the terminal first reads the learning target sentence with a sound of the foreign language content or with a TTS sound of the terminal, the terminal gives the learner time to infer how to express the learning target sentence in a second foreign language or to speak the learning target sentence aloud in the second foreign language and then reads the content of the corresponding subtitle in the second foreign language with the TTS sound, whereby the learner can perform foreign language learning while checking whether his or her inference is correct.

(4) A learning method in which the terminal sequentially reads the learning target sentences while skipping one by one, and the learner speaks the content of the next learning target sentence aloud or internally through inference of the content of the next learning target sentence of the learning target sentence read by the terminal.

In this learning method, in a way of sequentially reading the learning target sentences with a sound of the foreign language content or a TTS sound of the terminal corresponding to each of the learning target sentences while skipping the learning target sentences one by one, the terminal repeats a process of sequentially reading a preset number of learning target sentences set by the learner from the current learning target sentence, the learning target sentences from the current learning target sentence to the last learning target sentence, or the learning target sentences from the current learning target sentence until the learner stops the terminal reading the learning target sentences, giving the learner time to speak the content of the next learning target sentence aloud or to internally speak the content of the next learning target sentence through inference of the content of the next learning target sentence of the learning target sentence read by the terminal, followed by reading the next learning target sentence. This learning method may be used in the same situation as learning method (1). However, this learning method is suited for learners having almost memorized the sentences of the foreign language content to perform foreign language learning in the form of a role play in which the learner and the terminal alternately speak the sentences. A technical feature for implementing this learning method is the same as the technical feature of the above learning method (1) except that the terminal sequentially reads the learning target sentences while skipping one by one instead of continuously reading the learning target sentences and gives the learner an enough time to speak the learning target sentences.

One or more of the learning methods presented by the present invention may be produced, installed, and used in the form of applications in various devices.

Although the present invention has been described with reference to some embodiments in conjunction with the accompanying drawings, it should be understood that these embodiments are provided for illustration only and are not to be construed in any way as limiting the present invention. The scope of the present invention should be defined by the appended claims and equivalents thereto.

What is claimed is:

1. An interactive foreign language learning method using a speech recognition function and a TTS function of a terminal through speech transmission between the terminal and a learner based on foreign language content of a video containing multiple foreign language expressions, in which interactive foreign language learning is performed without screen touching by the learner or through minimization of screen touching by the learner by repeating a process in which the terminal informs the learner of a speech waiting state through a sound signal and/or screen display to allow the learner to input speech, executes operation in response to the speech input by the learner, and enters the speech waiting state again to allow the learner to input speech again,
the interactive foreign language learning method comprising:
a storage step in which voice commands to be transmitted to the terminal by the learner are previously stored in the terminal or in a storage unit, such as a server or the cloud;
a speech waiting mode step in which the terminal displays a speech waiting mode screen to inform the learner of the speech waiting state through the sound signal and/or screen display;
a conversion step in which, when the learner inputs speech in the speech waiting state, the terminal converts the content of the speech into text after determination of the content of the speech using a speech recognition function;
a comparison step in which the terminal determines whether the text converted in the conversion step matches a certain command among the voice commands stored in the terminal or in the storage unit;
an execution step in which the terminal executes a function corresponding to a corresponding voice command upon determining in the comparison step that the converted text matches any one of the voice commands; and
a speech waiting mode step in which the terminal displays the speech waiting mode screen again and informs the learner of the speech waiting state after execution of the function corresponding to the voice command in the execution step,
wherein, upon determining in the comparison step that the speech input by the learner does not match any one of the stored voice commands, the terminal determines that the learner speaks a certain sentence in learning target content and performs an operation corresponding to the speech input by the learner, the operation comprising any one process selected from among:
a process in which, upon determining that the speech input by the learner is the same as a current learning target sentence in the learning target content or belongs to the same category as the current learning target sentence, the terminal proceeds to the next learning target sentence of the current learning target sentence to read the next learning target sentence with a sound of the foreign language content or a TTS sound of the terminal corresponding thereto the number of times selected by the learner and enters the speech waiting state again, followed by informing the learner of the speech waiting state, and, upon determining that the speech input by the learner is neither the same as the current learning target sentence nor belongs to the same category as the current learning target sentence, the terminal reads the current learning target sentence to the learner with a sound of the foreign language content or a TTS sound of the terminal corresponding thereto the number of times selected by the learner and enters the speech waiting state again to allow the learner to input speech again in the speech waiting state;
a process in which, upon determining that the speech input by the learner is the same as the current learning target sentence or belongs to the same category as the current learning target sentence, the terminal proceeds to the next learning target sentence of the current learning target sentence to read a sentence spoken by the learner with a sound of the foreign language content or a TTS sound of the terminal corresponding thereto and enters the speech waiting state again to allow the learner to input speech with respect to the next learning target sentence in the speech waiting state, and upon determining that the converted text is neither the same as the current learning target sentence nor belongs to the same category as the current learning target sentence, the terminal reads the sentence spoken by the learner with the sound of the foreign language content or the TTS sound of the terminal corresponding thereto and enters the speech waiting state again to allow the learner to input speech again in the speech waiting state;
a process in which, upon determining that the speech input by the learner is the same as the current learning target sentence or belongs to the same category as the current learning target sentence, the terminal reads the next learning target sentence with the sound of the foreign language content or the TTS sound of the terminal corresponding to the next learning target sentence, proceeds to a sentence after the next learning target sentence to display the sentence after the next learning target sentence and a sentence after the sentence after the next learning target sentence on a screen thereof, and enters the speech waiting state, followed by informing the learner of the speech waiting state, and upon determining that the speech input by the learner is neither the same as the current learning target sentence nor belongs to the same category as the current learning target sentence, the terminal reads the current learning target sentence to the learner with the sound of the foreign language content or the TTS sound of the terminal corresponding thereto and enters the speech waiting state again to allow the learner to input speech again in the speech waiting state; and
a process in which, upon determining that the speech input by the learner is the same as the next learning target sentence in the learning target content or belongs to the same category as the next learning target sentence, the terminal reads a learning target sentence after the next learning target sentence to the learner with a sound of the foreign language content or a TTS sound of the terminal corresponding thereto and enters the speech waiting state, followed by informing the learner of the speech waiting state, and upon determining that the speech input by the learner does not match any one of the stored voice commands and is neither the same as the next learning target sentence nor belongs to the same category as the next learning target sentence, a determination is made as to whether the speech input by the learner is the same as the current learning target sentence in the learning target content or belongs to the same category as the current learning target sentence, and the terminal reads the next learning target sentence to the learner with the sound of the foreign language content or the TTS sound of the terminal corresponding thereto and enters the speech waiting state again, followed by informing the learner of the speech waiting state, upon determining that the speech input by the learner is the same as the current learning target sentence or belongs to the same category as the current learning target sentence, or the terminal reads the current learning target sentence to the learner with the sound of the foreign language content or the TTS sound of the terminal corresponding thereto and enters the speech waiting state again to allow the learner to input speech again in the speech waiting state, upon determining that the speech input by the learner does not match any one of the stored voice commands and is neither the same as any one of the current and next learning target sentences nor belongs to the same category as any one of the current and next learning target sentences,
wherein the terminal displays a video or an image corresponding to the learning target sentence on the screen of the terminal before, after or while the terminal reads the current learning target sentence or the next learning target sentence with the sound of the foreign language content or the TTS sound of the terminal corresponding thereto,
wherein the terminal displays the learning target sentences and subtitles corresponding to the learning target sentences on the screen of the terminal using a display method, the display method comprising any one of:
a process of displaying the current and next learning target sentences together with subtitles corresponding to each of the learning target sentences in a native language of the learner,
a process of marking some words of the current learning target sentence with blank spaces while displaying the remaining words of the current learning target sentence and the next learning target sentence together with the subtitles corresponding to the current and next learning target sentences in the native language of the learner, and
a process of making the entirety of the next learning target sentence disappear on the screen of the terminal to allow the learner to infer the content of the next learning target sentence read by the terminal, followed by displaying the next learning target sentence such that the learner checks whether the inferred content of the next learning target sentence is correct, when the terminal reads the next learning target sentence to the learner, and displaying the learning target sentence on the screen when the terminal or the learner reads or speaks the learning target sentence for which inference and confirmation of the learner has finished, and
wherein the terminal displays the total number of learning target sentences, a current learning target sentence number, a score given to the learner according to a learning result, and words not correctly spoken by the learner when the learner inputs speech with respect to an immediately previous learning target sentence, on the screen thereof.

2. The interactive foreign language learning method according to claim 1, wherein the terminal displays learning methods to be selected by the learner together with a current learning method used by the learner on the screen thereof, converts the current learning method into another learning method in response to a voice command of the learner, and changes display of the current learning method upon conversion of the learning method by the learner.

3. The interactive foreign language learning method according to claim 1, wherein the terminal displays a list of voice commands to be used by the learner on the screen thereof in response to a voice command of the learner.

4. The interactive foreign language learning method according to claim 1, wherein, upon determining in the comparison step that the speech input by the learner does not match any one of the voice commands, a method of determining similarity between the speech input by the learner and the learning target sentence is changed according to a length of the learning target sentence and/or a degree of difficulty of the learning target sentence set by the learner.

5. The interactive foreign language learning method according to claim 1, wherein additional voice commands capable of performing the same functions as the voice commands previously stored in the terminal or in the storage unit are further stored through registration to be used by the learner.

6. The interactive foreign language learning method according to claim 1, wherein, when the learner pushes a button displayed on the screen or speaks a voice command corresponding thereto, the terminal displays an input window for writing exercises including an input section on which the learner inputs the content of the current learning target sentence and an end button for closing the input window, and, when the learner pushes the input window end button, the terminal closes the input window for writing exercises and enters the speech waiting state again, followed by informing the learner of the speech waiting state to allow the learner to input speech in the speech waiting state.

7. The interactive foreign language learning method according to claim 1, wherein the learner is allowed to send or receive at least one of text messages, voice calls, and video calls with one or more learners performing foreign language learning through the same application program implementing the interactive foreign language learning method using the speech recognition function and the TTS function of the terminal.

8. The interactive foreign language learning method according to claim 7, wherein connection to a screen on which the learner can send the text messages, the voice calls or the video calls to the other learners performing foreign language learning through the same application program using the same learning method as the learner is realized when the learner pushes a button on the screen on which the learner performs foreign language learning or when the learner speaks a voice command corresponding to the button.

9. An interactive foreign language learning method using a speech recognition function and a TTS function of a terminal through speech transmission between the terminal and a learner based on foreign language content of a video containing multiple foreign language expressions, in which interactive foreign language learning is performed without screen touching by the learner or through minimization of screen touching by the learner by repeating a process in which the terminal informs the learner of a speech waiting state through a sound signal and/or screen display to allow the learner to input speech, executes operation in response to the speech input by the learner, and enters the speech waiting state again to allow the learner to input speech again,
the interactive foreign language learning method comprising:
a storage step in which voice commands to be transmitted to the terminal by the learner are previously stored in the terminal or in a storage unit, such as a server or the cloud;
a speech waiting mode step in which the terminal displays a speech waiting mode screen to inform the learner of the speech waiting state through the sound signal and/or screen display;
a conversion step in which, when the learner inputs speech in the speech waiting state, the terminal converts the content of the speech into text after determination of the content of the speech using a speech recognition function;
a comparison step in which the terminal determines whether the text converted in the conversion step matches a certain command among the voice commands stored in the terminal or in the storage unit;
an execution step in which the terminal executes a function corresponding to a corresponding voice command upon determining in the comparison step that the converted text matches any one of the voice commands; and
a speech waiting mode step in which the terminal displays the speech waiting mode screen again and informs the learner of the speech waiting state after execution of the function corresponding to the voice command in the execution step,
wherein, upon determining in the comparison step that the speech input by the learner does not match any one of the stored voice commands, the terminal determines that the learner speaks a certain sentence in learning target content and performs an operation corresponding to the speech input by the learner, the operation comprising any one selected from among:
a process in which, upon determining that the speech input by the learner is the same as a current learning target sentence in the learning target content or belongs to the same category as the current learning target sentence, after reading the next learning target sentence to the learner with a sound of the foreign language content or a TTS sound of the terminal corresponding thereto the number of times selected by the learner, the terminal sequentially reads previous learning target sentences, the current learning target sentence and the next learning target sentence with sounds of the foreign language content or TTS sounds of the terminal corresponding thereto a predetermined number of times and enters the speech waiting state again, followed by informing the learner of the speech waiting state, or after sequentially reading the previous learning target sentences, the current learning target sentence and the next learning target sentence with the sounds of the foreign language content or the TTS sounds of the terminal corresponding thereto a predetermined number of times, the terminal reads the next learning target sentence to the learner with the sound of the foreign language content or the TTS sound of the terminal corresponding thereto the number of times selected by the learner and enters the speech waiting state again, followed by informing the learner of the speech waiting state, and, upon determining that the speech input by the learner is neither the same as the current learning target sentence nor belongs to the same category as the current learning target sentence, the terminal reads the current learning target sentence to the learner with the sound of the foreign language content or the TTS sound of the terminal corresponding thereto and enters the speech waiting state again to allow the learner to input speech again in the speech waiting state;
a process in which, upon determining that the speech input by the learner is the same as the current learning target sentence in the learning target content or belongs to the same category as the current learning target sentence, after sequentially reading the next learning target sentence and a predetermined number of learning target sentences after the next learning target sentence with sounds of the foreign language content or TTS sounds of the terminal corresponding to the learning target sentences, the terminal reads the next learning target sentence with the sound of the foreign language content or the TTS sound of the terminal corresponding thereto the number of times selected by the learner and enters the speech waiting state, followed by informing the learner of the speech waiting state, or after reading the next learning target sentence with the sound of the foreign language content or the TTS sound of the terminal the number of times selected by the learner, the terminal sequentially reads learning target sentences after the next learning target sentence with a sound of the foreign language content or a TTS sound of the terminal corresponding to each of the learning target sentences a predetermined number of times and enters the speech waiting state, followed by informing the learner of the speech waiting state, and, upon determining that the speech input by the learner is neither the same as the current learning target sentence nor belongs to the same category as the current learning target sentence, the terminal reads the current learning target sentence to the learner with the sound of the foreign language content or the TTS sound of the terminal corresponding thereto the number of times selected by the learner and enters the speech waiting state again to allow the learner to input speech again in the speech waiting state;
a process in which, upon determining that the speech input by the learner is the same as the current learning target sentence in the learning target content or belongs to the same category as the current learning target sentence, after sequentially reading a predetermined number of previous learning target sentences, the current learning target sentence, the next learning target sentence, and a predetermined number of learning target sentences after the next learning target sentence with a sound of the foreign language content or a TTS sound of the terminal corresponding to each of the learning target sentences, the terminal reads the next learning target sentence with the sound of the foreign language content or the TTS sound of the terminal the number of times selected by the learner and enters the speech waiting state again to allow the learner to input speech again in the speech waiting state, or after reading the next learning target sentence with the sound of the foreign language content or the TTS sound of the terminal the number of times selected by the learner, the terminal sequentially reads a predetermined number of previous learning target sentences, the current learning target sentence, the next learning target sentence, and a predetermined number of learning target sentences after the next learning target sentence with the sound of the foreign language content or the TTS sound of the terminal corresponding to each of the learning target sentences and enters the speech waiting state again, followed by informing the learner of the speech waiting state, and upon determining that the speech input by the learner is neither the same as the current learning target sentence nor belongs to the same category as the current learning target sentence, the terminal reads the current learning target sentence to the learner with the sound of the foreign language content or the TTS sound of the terminal corresponding thereto the number of times selected by the learner and enters the speech waiting state again to allow the learner to input speech again in the speech waiting state; and
a process in which, upon determining that the speech input by the learner is the same as the current learning target sentence in the learning target content or belongs to the same category as the current learning target sentence, after reading the next learning target sentence with the sound of the foreign language content or the TTS sound of the terminal the number of times selected by the learner, the terminal displays an input window for writing exercises including an input section on which the learner inputs the content of the next learning target sentence and an end button for closing the input window, and closes the input window for writing exercises when the learner pushes the input window end button, and enters the speech waiting state again, followed by informing the learner of the speech waiting state, and upon determining that the speech input by the learner is neither the same as the current learning target sentence nor belongs to the same category as the current learning target sentence, the terminal reads the current learning target sentence to the learner with the sound of the foreign language content or the TTS sound of the terminal corresponding thereto the number of times selected by the learner and enters the speech waiting state again to allow the learner to input speech again in the speech waiting state,
wherein the terminal displays a video or an image corresponding to the learning target sentence on the screen of the terminal before, after or while the terminal reads the current learning target sentence or the next learning target sentence with the sound of the foreign language content or the TTS sound of the terminal corresponding thereto, and
wherein the terminal displays the current and next learning target sentences together with subtitles corresponding to each of the learning target sentences in a native language of the learner.

10. An interactive foreign language learning method using a speech recognition function and a TTS function of a terminal through speech transmission between the terminal and a learner based on foreign language content of a video containing multiple foreign language expressions, in which interactive foreign language learning is performed without screen touching by the learner or through minimization of screen touching by the learner by repeating a process in which the terminal informs the learner of a speech waiting state through a sound signal and/or screen display to allow the learner to input speech, executes a process corresponding to the speech input by the learner, and enters the speech waiting state again to allow the learner to input speech again,
the interactive foreign language learning method comprising:
a storage step in which voice commands to be transmitted to the terminal by the learner are previously stored in the terminal or in a storage unit, such as a server or the cloud;
a speech waiting mode step in which the terminal displays a speech waiting mode screen to inform the learner of the speech waiting state through the sound signal and/or screen display;
a conversion step in which, when the learner inputs speech in the speech waiting state, the terminal converts the content of the speech into text after determination of the content of the speech using a speech recognition function;
a comparison step in which the terminal determines whether the text converted in the conversion step matches a certain command among the voice commands stored in the terminal or in the storage unit;
an execution step in which the terminal executes a function corresponding to a corresponding voice command upon determining in the comparison step that the converted text matches any one of the voice commands; and
a speech waiting mode step in which the terminal displays the speech waiting mode screen again and informs the learner of the speech waiting state after execution of the function corresponding to the voice command in the execution step,
wherein, upon determining in the comparison step that the speech input by the learner does not match any one of the stored voice commands, a determination is made as to whether the speech input by the learner is the same as second foreign language subtitles of the current learning target sentence in the learning target content or belongs to the same category as the second foreign language subtitles, and, upon determining that the speech input by the learner is the same as the second foreign language subtitles or belongs to the same category as the second foreign language subtitles, the terminal proceeds to the next learning target sentence of the current learning target sentence to read the second foreign language subtitles corresponding to the next learning target sentence to the learner with a TTS sound corresponding thereto the number of times selected by the learner, and enters the speech waiting state again, followed by informing the learner of the speech waiting state, and upon determining that the speech input by the learner is not the same as the second foreign language subtitles or does not belong to the same category as the second foreign language subtitles, the terminal reads the second foreign language subtitles corresponding to the current learning target sentence to the learner with a TTS sound corresponding thereto the number of times selected by the learner, and enters the speech waiting state again to allow the learner to input speech in the speech waiting state,
wherein the terminal displays a video or an image corresponding to the learning target sentence on the screen of the terminal to allow the learner to watch the video or the image, before, after or while the terminal reads the current learning target sentence or the next learning target sentence with the sound of the foreign language content or the TTS sound of the terminal corresponding thereto,
wherein the terminal displays the learning target sentences and subtitles corresponding to the learning target sentences on the screen of the terminal using a display method, the display method comprising:
a process in which the terminal displays some words of the second foreign language subtitles corresponding to the current learning target sentence with blank spaces while displaying the remaining words of the second foreign language subtitles on the screen thereof together with the current learning target sentence, the next learning target sentence, and second foreign language subtitles of the next learning target sentence to allow the learner to speak the content of the second foreign language subtitles corresponding to the current learning target sentence while inferring the words of the second foreign language subtitles of the current learning target sentence marked with the blank spaces.

11. The interactive foreign language learning method according to claim 10, wherein the terminal allows the learner to select a language among languages used for subtitles displayed on the screen as a subtitle language to be read by the terminal and displays the name of the subtitle language selected by the learner on the screen.

12. An interactive foreign language learning method using a speech recognition function and a TTS function of a terminal through speech transmission between the terminal and a learner, in which interactive foreign language learning is performed using foreign language content of a video containing multiple foreign language expressions,
wherein the terminal continues to read a preset number of learning target sentences set by the learner from the current learning target sentence, to read the learning target sentences from the current learning target sentence to the last learning target sentence, or to read the learning target sentences from the current learning target sentence until the learner stops the terminal reading the learning target sentences, the learning target sentences being read by any one reading method selected from among:
a reading method in which the terminal repeats a process of sequentially reading the learning target sentences with a sound of the foreign language content or a TTS sound of the terminal corresponding to each of the learning target sentences the number of times selected by the learner, and giving the learner time to speak aloud after the terminal or to speak internally after the terminal, followed by reading the next learning target sentence;
a reading method in which the terminal repeats a process of sequentially reading subtitles corresponding to the learning target sentences in a native language of the learner with sounds of the foreign language content or TTS sounds of the terminal corresponding to the learning target sentences the number of times selected by the learner, sequentially reading the learning target sentences with the sound of the foreign language content or the TTS sound of the terminal corresponding thereto, and giving the learner time to speak aloud after the terminal or to speak internally after the terminal, followed by reading the next learning target sentence;
a reading method in which the terminal repeats a process of sequentially reading the learning target sentence with sounds of the foreign language content or TTS sounds of the terminal corresponding thereto, reading second foreign language subtitles corresponding to the learning target sentences to the learner with the TTS sounds the number of times selected by the learner, and giving the learner time to speak aloud after the terminal or to speak internally after the terminal, followed by reading the next learning target sentence; and
a reading method in which the terminal repeats a process of sequentially reading the learning target sentences with a sound of the foreign language content or a TTS sound of the terminal corresponding to each of the learning target sentences while skipping one by one, and giving the learner time to speak the next learning target sentence aloud or to speak the next learning target sentence internally, followed by reading the next learning target sentence to the learner,
the interactive foreign language learning method comprising:
a video or image display step in which the terminal displays a video or an image corresponding to the learning target sentence on the screen of the terminal to allow the learner to watch the video or the image, before, after or while the terminal reads the current learning target sentence or the next learning target sentence with the sound of the foreign language content or the TTS sound of the terminal corresponding thereto; and
a subtitle display selection step in which the terminal displays the content of the current learning target sentence and the next learning target sentence together with or without the entirety or some of subtitles in a native language of the learner corresponding to each of the learning target sentences on the screen thereof according to learner selection.
